(19) United States
(12) Patent Application Publication
(10) Pub. No.: US 2015/0294513 A1
(43) Pub. Date: Oct. 15, 2015

(54) COUNTING APPARATUS FOR RECOGNIZING ENTRANCE/EXIT DIRECTIONS AND METHOD THEREFOR

(71) Applicant: BOTEM CO., LTD., Daejeon (KR)

(72) Inventor: Hyo Goo Kim, Daejeon (KR)

(21) Appl. No.: 14/409,015

(22) PCT Filed: Apr. 4, 2013
(86) PCT No.: PCT/KR2013/002800

§ 371 Date: Dec. 18, 2014

(30) Foreign Application Priority Data
Apr. 5, 2012 (KR) 10-2012-0035751

(51) Int. Cl. G07C 9/00

(52) U.S. Cl. CPC G07C 9/00

(57) ABSTRACT

Provided is a sensor for supplying and cutting off power, and more particularly, a counting apparatus and a method for recognizing entrance/exit directions which efficiently supply or cut off the power by sensing the number of entrance/exit users without an error.

### TECHNICAL FIELD

The present invention relates to a sensor for supplying and cutting off power, and more particularly, to a counting apparatus and a method for recognizing entrance/exit directions which efficiently supply or cut off the power by sensing the number of entrance/exit users without an error.

### BACKGROUND ART

Modern people use various supply sources which are installed in their living spaces to make their daily life much convenient. In particular, it is a known fact that a water supply source which allows people to conveniently use clean water, a gas supply source which generates heating power enough to allow them to cook food at low cost, a power supply source which allows them to use various electric facilities such as a light, and the like are utilities which are essentially installed in the living spaces of modern people. According to the purpose of a building, all the utilities as described above need to be installed in a residential space, while the power supply source is essentially installed in an office, a lecture room, and the like other than the residential space.

Even though the foregoing utilities make a life very convenient for people, they are likely to cause problems when they have minor repairs or are malfunctioned. In particular, if a problem or a malfunction occurs when a person is not present, the problem or malfunction may be undetected nor fixed for an extended period of time, which may cause additional or larger problems. In particular, when a person goes out for a long period of time while a valve is open or a gas range is on without knowing that gas is leaking, the leaked gas may accumulate in a room. As a result, when a person enters the corresponding space after returning home, he/she inhales gas and as a result becomes sick due to the gas or when a person approaches the gas range, and the like, a large explosion or a fire may occur.

The big accidents and energy waste due to leakage of electricity, water, and the like are becoming a serious issue. In particular, since an office, a lecture room, public buildings, and the like require high illumination and have many visitors who go in and out there at any time due to characteristics of the purpose of the buildings, most of the buildings keep lights turned on to consume a lot of power. However, for example, in the case the lecture room, after a lecture is over, the last one who goes out from the lecture room turns off lights in the lecture room. However, when the last one who goes not from the lecture room is uncertain and responsibility is diffused to several persons, as it is well known that people are extremely less likely to do something for themselves in behavioristic psychology, it is known that lights are not properly turned off within the space which is used by many peoples. As described above, even though no person is present in a space and thus there is no need to turn on lights, lights are turned on within the space and therefore a considerable amount of power is consumed. In addition, lights are left, being turned on for a long period of time, and as a result, the occurrence of various problems such as a damage to electric facilities and spoilage of furniture and small tools in the corresponding space due to overheating may not be ruled out.

Therefore, to solve the above problems, apparatuses for automatically cutting-off a water supply source, a gas supply source, a power supply source, and the like by sensing that no person is present in a room are described. In particular, the apparatus for controlling an operation by simply sensing a person's behavior hardly senses entrance/exit, and therefore an apparatus for accurately sensing when at least one person is present and when no person is present by accurately identifying and counting the entrance/exit users is required. To identify and count the entrance/exit users, at least two sensors are required to be installed, and thus the entrance/exit users need to be identified and counted depending on the sensing order of each sensor, which is also disclosed in the related arts. However, the related art has a problem in that a malfunction may occur due to noise interference between a plurality of sensors since the sensors using the same current are simultaneously operated. Further, it is difficult for the related arts to be implemented in a wireless type manner since the sensor or the terminal consumes a considerable amount of power, which makes an installation operation complicated since an electrical construction and a power construction for supplying operation power in a wired type are required.

### DISCLOSURE

### Technical Problem

An object of the present invention is to provide a counting apparatus and a method for recognizing entrance/exit directions capable of accurately identifying and counting entrance or exit users using a combination of a plurality of operation recognition sensors and heat sensors which are sequentially operated and minimizing noise interference between the respective sensors.

Further, another object of the present invention is to provide a counting apparatus and a method for recognizing entrance/exit directions which may be implemented in a wireless type by minimizing power consumption of each sensor.

### Technical Solution

In one general aspect, a counting apparatus for recognizing entrance/exit directions, includes: a first sensing unit configured to be disposed within an object space, sense a moving body within a first sensing range which is configured to be at an entrance/exit side or toward an adjacent portion to the entrance/exit side; a second sensing unit configured to be disposed within the object space and sense a moving body within a second sensing range which is configured to be toward a space spaced apart from the first sensing range at a predetermined distance; a third sensing unit configured to be disposed within the object space and sense a moving body within a third sensing range which is configured to be toward a space between the first sensing range and the second sensing range; and a control unit configured to confirm whether the moving body is sensed by the first sensing unit or the second sensing unit when the moving body deviates from the third sensing range to increase a count of the moving body by +1 when the second sensing unit senses the moving body and reduce the count of the moving body by −1 when the first sensing unit senses the moving body.

The first sensing unit and the second sensing unit may include an operation sensing sensor sensing an operation of the moving body and the third sensing unit may include a heat sensing sensor sensing heat of the moving body.

The third sensing range may include a first overlapping range overlapping the first sensing range and a second overlapping range overlapping the second sensing range.

The third sensing range may be equal to or larger than a sum of the first overlapping range and the second overlapping range.

The control unit may stop an operation of the first sensing unit when the first sensing unit senses the moving body and then the moving body enters the first overlapping range, stop an operation of the second sensing unit when the second sensing unit senses the moving body and then the moving body enters the second overlapping range, and resume the operation of the first sensing unit and the second sensing unit when the moving body deviates from the third sensing range.

At least two of the first sensing unit, the second sensing unit, and the third sensing unit may be packaged in a single operation sensing sensor.

In another general aspect, a counting method for recognizing entrance/exit directions, includes: sensing, by a first sensing unit, a moving body when the moving body is entered; sensing, by a third sensing unit, the moving body; confirming whether the first sensing unit or the second sensing unit senses the moving body when the moving body deviates from a third sensing range; increasing a count of the moving body by +1 when the second sensing unit senses the moving body; sensing, by the second sensing unit, the moving body when the moving body exits; sensing, by a third sensing unit, the moving body; confirming whether the first sensing unit or the second sensing unit senses the moving body when the moving body deviates from a third sensing range; and reducing the count of the moving body by −1 when the first sensing unit senses the moving body.

The counting method may further include: stopping an operation of the first sensing unit when the moving body enters the third sensing range or the first overlapping range after the first sensing unit senses the moving body; and stopping an operation of the second sensing unit when the moving body enters the third sensing range or the second overlapping range after the second sensing unit senses the moving body.

The counting method may further include: stopping an operation of the first sensing unit when the first sensing unit senses the moving body, stopping the operation of the second sensing unit when the third sensing unit senses the moving body, or stopping the operation of the second sensing unit when the second sensing unit senses the moving body and stopping the operation of the first sensing unit when the third sensing unit senses the moving body.

The counting method may further include: resuming the operation of the first sensing unit and the second sensing unit when the moving body deviates from the third sensing range.

### Advantageous Effects

According to the counting apparatus and the method for recognizing entrance/exit directions according to the exemplary embodiments of the present invention having the configuration as described above, it is possible to save supply resources and effectively prevent various safety accidents which are likely to occur in the corresponding space, by accurately sensing when at least one person is present and when no person is present so as to supply or cut-off the gas supply source, the water supply source, the power supply source, and the like which are installed in the corresponding space.

In particular, it is possible to facilitate the installation and maintenance of the counting apparatus and the method for recognizing entrance/exit directions by implementing the counting apparatus and the method for recognizing entrance/exit directions in a wireless type and at low cost.

Further, it is possible to rapidly rescue human life and help prevent the safety accidents due to an unnecessary confirmation operation of a rescuer, by accurately figuring out occupancy people in building when various kinds of disasters occur.

Further, it is possible to prevent the safety accidents by installing the counting apparatus according to the exemplary embodiment of the present invention in a front door, a room, a toilet, and the like of a house and transmitting the entrance/exit state of family to a personal computer or a mobile in real time, and provide the counting apparatus which may accept the guidance of the entrance/exit of family and perform the security function.

Further, it is possible to prevent the safety accidents by transmitting an alarm message when the check in counting into the specific space is generated and then the check out counting is not generated for a long period of time.

Further, it is possible to conveniently rescue human life when disasters occur by figuring out the occupancy people in each space in real time when a fire and various kinds of disasters occur in an office building, a school, a factory, and the like.

Further, it is possible to prevent the invaders from invading and early suppress the invaders by accurately identifying whether the invaders run away, how many the invaders currently remain in the specific space when multiple invaders invade, and the like by accurately counting the number of invaders into the specific space.

### DESCRIPTION OF DRAWINGS

FIG. 1 is a schematic diagram of a counting apparatus according to an exemplary embodiment of the present invention.

FIG. 2 is a schematic diagram of a counting apparatus according to another exemplary embodiment of the present invention.

FIG. 3 is an operation flow chart of a counting method according to a first exemplary embodiment of the present invention (entrance).

FIG. 4 is the operation flow chart of the counting method according to the first exemplary embodiment of the present invention (exit).

FIG. 5 is an operation flow chart of a counting method according to a second exemplary embodiment of the present invention (entrance).

FIG. 6 is the operation flow chart of the counting method according to the second exemplary embodiment of the present invention (exit).

FIG. 7 is an operation flow chart of a counting method according to a third exemplary embodiment of the present invention (entrance).

FIG. 8 is the operation flow chart of the counting method according to the third exemplary embodiment of the present invention (exit).

### DETAILED DESCRIPTION OF MAIN ELEMENTS

100, 200: Object space

101, 201: Entrance

110, 210: First sensing unit

120, 220: Second sensing unit

130, 230: Third sensing unit

250: Operation sensing sensor

S1, S4: First sensing range

S2, S5: Second sensing range

S3, S6: Third sensing range

R1, R3: First overlapping range

R2, R4: Second overlapping range

### Best Mode

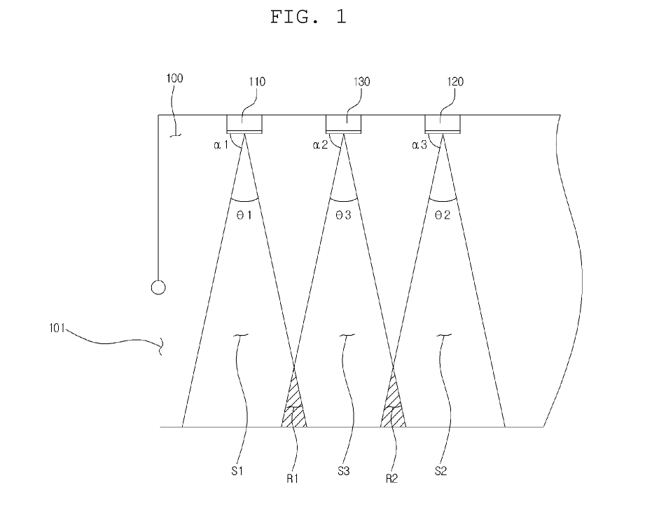

FIG. 1 schematically illustrates a counting apparatus for recognizing entrance/exit directions according to an exemplary embodiment of the present invention. A counting system for recognizing entrance/exit directions according to an exemplary embodiment of the present invention is installed within an object space 100. Therefore, the counting system for recognizing entrance/exit directions is configured to sense the entrance/exit of moving bodies within the object space 100 to measure the number of moving bodies within the object space 100. Further, the counting system is connected to a water supply apparatus, a gas supply apparatus, a power supply apparatus, and the like to supply water, gas, and electricity or keep a supply state when at least one moving body is present within the object space 100 and cut-off water, gas, and electricity when no moving body is present or keep a cut-off state.

The object space 100 may be any space which may be divided into an inside and an outside, like a residential space of general home and apartment, and the like, a lecture room, an office, and public buildings.

Hereinafter, a counting apparatus for recognizing entrance/exit directions according to an exemplary embodiment of the present invention will be described in detail with reference to the accompanying drawings.

### Embodiment 1

Referring to FIG. 1, a counting apparatus for recognizing entrance/exit directions according to an exemplary embodiment of the present invention is configured to include a first sensing unit 110, a second sensing unit 120, and a third sensing unit 130.

The first sensing unit 110 is configured to sense a motion of a moving body at an entrance 101 side of the object space 100 or in a space adjacent to the entrance 101 side. That is, the first sensing unit 110 senses the entrance/exit of the moving bodies. In detail, the first sensing unit 110 senses a motion of a moving body within a first sensing range S1 which is configured to be at the entrance 101 side of the object space 100 or toward the entrance 101 side. The first sensing range S1 has a fan-shaped longitudinal section and may be expanded by a first sector angle θ1 from the first sensing unit 110. The first sensing range S1 may sense a space displaced by a predetermined angle at a surface just under the first sensing unit 110 by controlling a first alpha angle α1. Here, FIG. 1 illustrates that the first sensing unit 110 is adjacently disposed at the entrance 101 side, but it is apparent that the first sensing range S1 may be disposed at any of an inside or an outside of the object space 100 which has a distance and the first alpha angle α1 enough to sense the motion of the moving object at the entrance 101 side or within the space adjacent to the entrance 101 side.

As the first sensing unit 110, an operation sensing sensor which senses the motion of the moving body may be applied. For example, as the first sensing unit 110, a digital pyroelectric infrared sensor (PIR) movement sensor may be applied.

Although not illustrated in FIG. 1, when several entrance 101 are present in the object space 100, the first sensing unit 110 is disposed at each entrance 101 and thus a plurality of first sensing units 110 may be provided per one object space 100.

The second sensing unit 120 is disposed inside the object space 100 to sense the motion of the moving body within the object space 100. In detail, the second sensing unit 120 may be formed to be spaced apart from the first sensing unit 110 at a predetermined distance. This is to sense the motion of the moving body which exits to the entrance 101 side. In detail, the second sensing unit 120 senses the motion of the moving body within a second sensing range S2 which is configured to be toward a space spaced apart from the first sensing range S1 at a predetermined distance. The second sensing range S2 has a fan-shaped longitudinal section and may be expanded by a second sector angle θ2 from the second sensing unit 120. The second sensing range S2 may sense a space displaced by a predetermined angle at a surface just under the second sensing unit 120 by controlling a second alpha angle α2. Therefore, it is apparent that the second sensing unit 120 may be disposed at any of the inside or the outside of the object space 100 which has a distance and the second alpha angle α2 enough to sense the motion of the moving body within the space in which the second sensing range S2 is spaced apart from the first sensing range S1 at a predetermined distance.

At least one or a plurality of second sensing units 120 may be installed to correspond to the number of first sensing units 110. As the second sensing unit 120, the operation sensing sensor which senses the motion of the moving body may be applied. For example, as the second sensing unit 120, the digital pyroelectric infrared sensor (PIR) movement sensor may be applied.

The above configuration is enough to sense the entrance/exit of the moving body to count the number of moving bodies, but may be malfunctioned due to the noise interference between the plurality of sensors when the plurality of operation sensing sensors using the same current are simultaneously used. Therefore, the present invention has the follow characteristic configuration.

The third sensing unit 130 is installed inside the object space 100 and may be installed to be spaced apart from the first sensing unit 110 and the second sensing unit 120 at a predetermined distance. FIG. 1 illustrates that the third sensing unit 130 is installed between the first sensing unit 110 and the second sensing unit 120, but the third sensing unit 130 may be installed at any position which may satisfy a condition of the third sensing range S3 to be described below. In detail, the third sensing unit 130 senses the heat of the moving body within the third sensing range S3 which is configured to be toward a space between the first sensing range S1 and the second sensing range S2. The third sensing range S3 has a fan-shaped longitudinal section and may be expanded by a third sector angle θ3 from the third sensing unit 130. The third sensing range S3 may sense a space displaced by a predetermined angle at a surface just under the third sensing unit 130 by controlling a third alpha angle α3. Therefore, it is apparent that the third sensing unit 130 may be disposed at any of the inside or the outside of the object space 100 which has a distance and the third alpha angle α3 enough to sense heat of a moving body within the space between the first sensing range S1 and the second sensing range S2.

As the third sensing unit 130, a general heat sensing sensor which senses the heat of the moving body may be applied. For example, a temperature sensor, an infrared sensor, and the like may be applied. In more detail, as the third sensing unit 130, the digital pyroelectric infrared sensor (PIR) temperature sensor may be applied. At least one or a plurality of third sensing units 130 may be installed to correspond to the number of first sensing units 110 or second sensing unit 120.

In this case, the third sensing range S3 includes a first overlapping range R1 which overlaps the first sensing range S1. Further, the third sensing range S3 includes a second overlapping range R2 which overlaps the second sensing range S2. Therefore, the third sensing range S3 may be configured to be equal or larger than a sum of the first overlapping range R1 and the second overlapping range R2.

### Embodiment 2

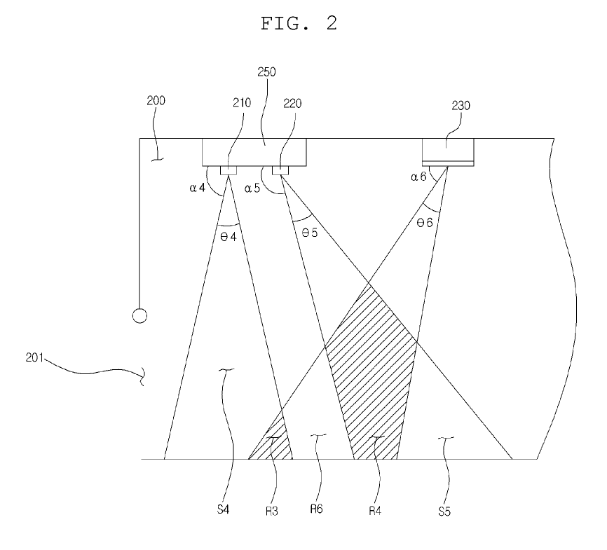

Referring to FIG. 2, a counting apparatus for recognizing entrance/exit directions according to an exemplary embodiment of the present invention is configured to include an operation sensing sensor 250 including a first sensing unit 210 and a second sensing unit 220 and a third sensing unit 230. The operation sensing sensor 250 may be configured as a package including the first sensing unit 210 and the second sensing unit 220.

The first sensing unit 210 is configured to sense motions of moving bodies at an entrance 101 side of the object space 100 or in a space adjacent to the entrance 101 side. That is, the first sensing unit 210 senses the entrance/exist of the moving bodies. In detail, the first sensing unit 210 senses a motion of a moving body within a fourth sensing range S4 which is configured to be at the entrance 101 side of the object space 100 or toward the entrance 101 side thereof. The fourth sensing range S4 has a fan-shaped longitudinal section and may be expanded by a fourth sector angle θ4 from the first sensing unit 210. The fourth sensing range S4 may sense a space displaced by a predetermined angle at a surface just under the first sensing unit 210 by controlling a fourth alpha angle α4. Here, FIG. 2 illustrates that the operation sensing sensor 250 is adjacently disposed at the entrance 101 side, but it is apparent that the fourth sensing range S4 may be disposed at any of inside or outside of the object space 100 which has a distance and an angle enough to sense the motion of the moving body at the entrance 101 side or within the space adjacent to the entrance 101 side.

The second sensing unit 220 is disposed inside the object space 100 to sense the motion of the moving body within the object space 100. In detail, the second sensing unit 220 may be formed to be spaced apart from the first sensing unit 210 at a predetermined distance. This is to sense the motion of the moving body which exits to the entrance 101 side. In detail, the second sensing unit 220 senses the motion of the moving body within a fifth sensing range S5 which is configured to be toward a space spaced apart from the fourth sensing range S4 at a predetermined distance. The fifth sensing range S5 has a fan-shaped longitudinal section and may be expanded by a fifth sector angle θ5 from the second sensing unit 220. The fifth sensing range S5 may sense a space displaced by a predetermined angle at a surface just under the second sensing unit 220 by controlling a fifth alpha angle α5. Therefore, it is apparent that the operation sensing sensor 250 may be disposed at any of the inside or the outside of the object space 100 which has a distance and an angle enough to sense a motion of a moving body within the space in which the fifth sensing range S5 is spaced apart from the fourth sensing range S4 at a predetermined distance.

The third sensing unit 230 is installed inside the object space 100 and may be installed to be spaced apart from the first sensing unit 210 and the second sensing unit 220 at a predetermined distance. FIG. 2 illustrates that the third sensing unit 230 is installed between the first sensing unit 210 and the second sensing unit 220, but the third sensing unit 230 may be installed at any position which may satisfy a condition of a sixth sensing range S6 to be described below. In detail, the third sensing unit 230 senses heat of a moving body within a sixth sensing range S6 which is configured to be toward a space between the fourth sensing range S4 and the fifth sensing range S5. The sixth sensing range S6 has a fan-shaped longitudinal section and may be expanded by a sixth sector angle θ6 from the third sensing unit 230. The sixth sensing range S6 may sense a space displaced by a predetermined angle at a surface just under the third sensing unit 230 by controlling a sixth alpha angle α6. Therefore, it is apparent that the third sensing unit 230 may be disposed at any of the inside or the outside of the object space 100 which has a distance and an angle enough to sense heat of a moving body within the space between the fourth sensing range S4 and the fifth sensing range S5.

In this case, the third sensing range S6 includes a first overlapping range R3 which overlaps the first sensing range S4. Further, the third sensing range S6 includes a second overlapping range R4 which overlaps the second sensing range S5. Therefore, the third sensing range S6 may be configured to be equal or larger than a sum of the first overlapping range R3 and the second overlapping range R4.

Hereinafter, a configuration of a control unit (not illustrated) for controlling the counting system for recognizing entrance/exit directions according to the first and second exemplary embodiments of the present invention as described above will be described in detail with reference to the accompanying drawings. The control unit has a configuration which may be applied both to the first and second exemplary embodiments of the present invention, and therefore the configuration of the first exemplary embodiment of the present invention will be described in detail. The control unit is wirelessly connected to the first sensing unit 110, the second sensing unit 120, and the third sensing unit 130 which are installed within the object space 100 to use signals transmitted from the sensors so as to count the moving body within the object space 100. Further, the control unit is connected to a control device of a water supply source, a gas supply source, or a power supply source which is connected to the object space 100 in a wired or wireless manner so as to connect or disconnect the control device depending on whether the moving body is present in the object space 100. Hereinafter, an operation method of the control unit will be described in more detail.

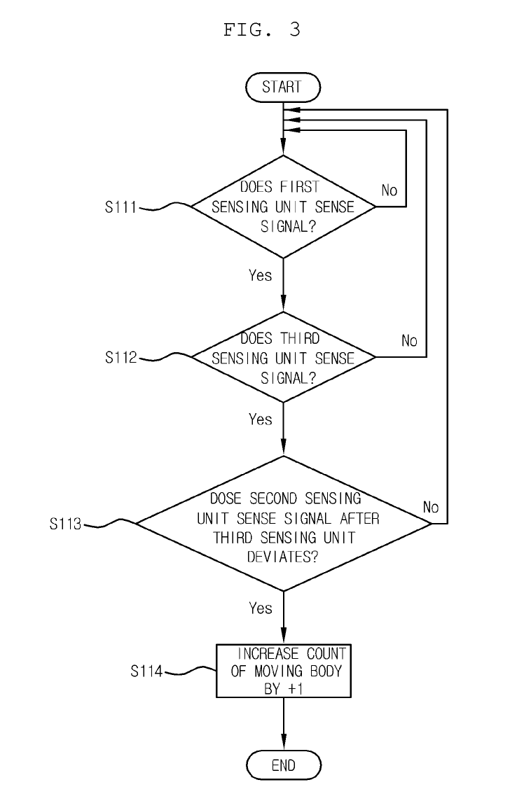

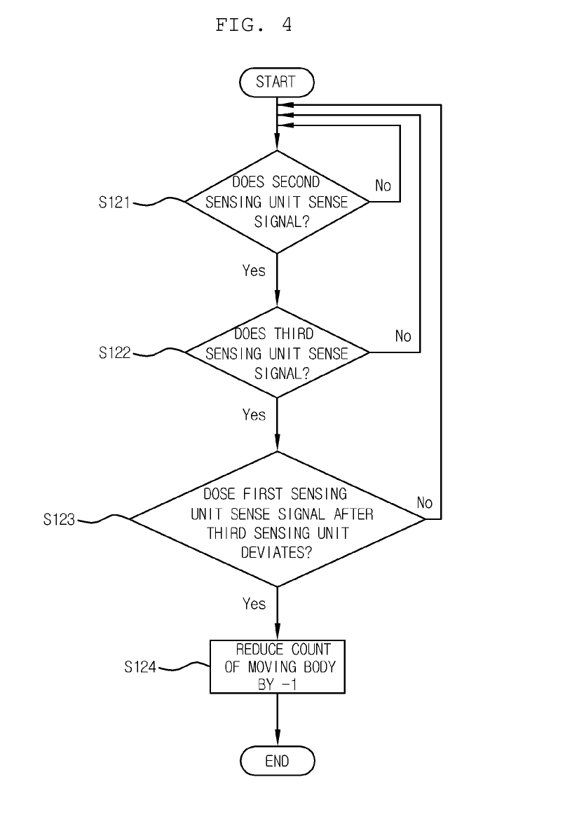

FIGS. 3 and 4 illustrate an operation flow chart of a counting method for recognizing entrance/exit direction according to a first exemplary embodiment of the present invention. FIG. 3 illustrates a counting method when the moving body is entered and FIG. 4 illustrates a counting method when the moving body exits.

Referring to FIG. 3, first, the control unit 30 determines whether the entrance of the moving body is sensed by the first sensing unit 110 (S111). When the moving body passes through the entrance 101 of the object space 100, the entrance of the moving body is sensed by the first sensing unit 110 (S111-Yes) and then the control unit determines whether the moving body is sensed by the third sensing unit 130 (S112). When the moving body is continuously attempted to be entered, the heat of the moving body is sensed by the third sensing unit 130 (S112-Yes) and then when the moving body deviates from the third sensing range S3 of the third sensing unit 130, it is determined whether the entrance of the moving body is sensed by the second sensing unit 120 (S113). This is a step of determining the entrance of the moving body and when the entrance of the moving body is determined, the entrance determination of the moving body is sensed by the second sensing unit 120 (S113-Yes) and then the count of the moving body is increased by +1 (S114). That is, according to the exemplary embodiment of the present invention, the control unit increases the number of moving bodies within the object space 100 by 1 when the entrance of the moving body is determined by the first to third sensing units.

The control unit is operated like a flow chart illustrated in FIG. 3 and accurately determines when the moving body again exits the entrance 101 while the moving body enters the object space 100 and when the entrance of the moving body into the object space 100 is determined to count the number of moving bodies.

Further, referring to FIG. 4, first, a control unit 30 determines whether the exit of the moving body is sensed by the second sensing unit 120 (S121). When the moving body attempts to exit from the object space 100, the exit of the moving body is sensed by the second sensing unit 120 (S121-Yes) and then the control unit determines whether the moving body is sensed by the third sensing unit 130 (S122). When the moving body continuously attempts to exit, the heat of the moving body is sensed by the third sensing unit 130 (S122-Yes) and then when the moving body deviates from the third sensing range S3 of the third sensing unit 130, it is determined whether the exit to the entrance 101 side of the moving body is sensed by the first sensing unit 110 (S123). This is a step of determining the exit of the moving body and when the exit of the moving body is determined, the exit of the moving body to the entrance 101 is sensed by the first sensing unit 110 (S123-Yes) and then the count of the moving body is reduced by −1. That is, according to the exemplary embodiment of the present invention, the control unit reduces the number of moving bodies within the object space 100 by 1 when the exit of the moving body is determined by the first to third sensing units.

The control unit is operated like a flow chart illustrated in FIG. 4 and accurately determines when the moving body again enters the object space 100 while the moving body exits and when the exit to the entrance 101 is determined to count the number of moving bodies.

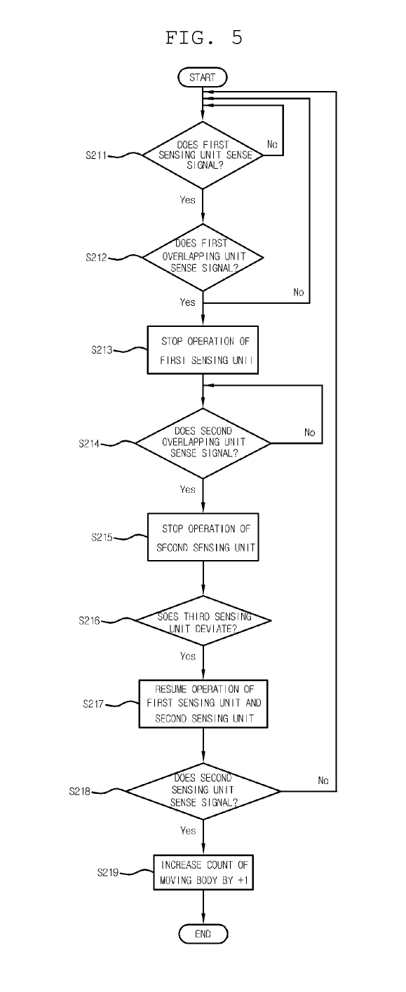

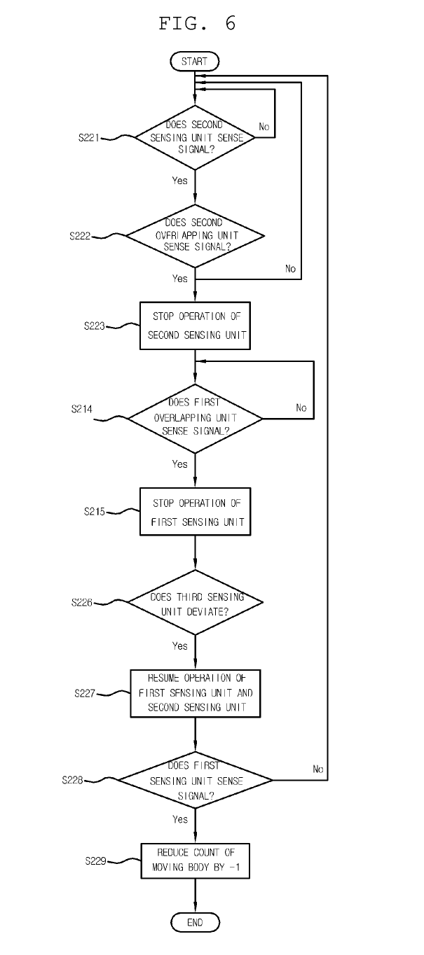

FIGS. 5 and 6 illustrate an operation flow chart of a counting method for recognizing entrance/exit directions according to a second exemplary embodiment of the present invention. FIG. 5 illustrates a counting method when the moving body enters and FIG. 6 illustrates a counting method when the moving body exits.

Referring to FIG. 5, first, the control unit determines whether the entrance of the moving body is sensed by the first sensing unit 110 (S211). When the moving body passes through the entrance 101 of the object space 100, the entrance of the moving body is sensed by the first sensing unit 110 (S211-Yes) and then the control unit determines whether the moving body is sensed by the first overlapping part R1 of the third sensing unit 130 (S212). When the moving body is continuously attempted to be entered, the heat of the moving body is sensed by the third sensing unit 130 (S212-Yes) and the operation of the first sensing unit 110 stops (S213). Next, the control unit determines whether the moving body is sensed by the second overlapping part R2 of the third sensing unit 130 (S214). If it is determined that the moving body in the second overlapping part R2 is sensed (S214-Yes), the operation of the second sensing unit 120 stops (S215).

Next, it is determined whether the moving body deviates from the third sensing range S3 of the third sensing unit 130 (S216) and if it is determined that the moving body deviates from the third sensing range S3 (S216-Yes), the operation of the first sensing unit 110 and the second sensing unit 120 is resumed (S217). Next, it is determined whether the entrance of the moving body is sensed by the second sensing unit 120 (S218). This is a step of determining the entrance of the moving body and when the entrance of the moving body is determined, the entrance determination of the moving body is sensed by the second sensing unit 120 (S218-Yes) and then the count of the moving body is increased by +1 (S219). That is, according to the exemplary embodiment of the present invention, the control unit increases the number of moving bodies within the object space 100 by 1 when the entrance of the moving body is determined by the first to third sensing units.

The control unit is operated like a flow chart illustrated in FIG. 5 and accurately determines when the moving body again exits the entrance 101 while the moving body enters the object space 100 and when the entrance into the object space 100 is determined to count the number of moving bodies. Further, the error due to the mutual interference between the first sensing unit 110 and the second sensing unit 120 using the same current is minimized and thus the accuracy is more improved.

Further, referring to FIG. 6, first, the control unit 30 determines whether the exit of the moving body is sensed by the second sensing unit 120 (S221). When the moving body attempts to exit from the object space 100, the exit of the moving body is sensed by the second sensing unit 120 (S221-Yes) and then the control unit determines whether the moving body is sensed by the second overlapping part R2 of the third sensing unit 130 (S222). When the moving body continuously attempts to exit, the heat of the moving body is sensed by the third sensing unit 130 (S222-Yes) and the operation of the second sensing unit 120 stops (S223). Next, the control unit determines whether the moving body is sensed by the first overlapping part R1 of the third sensing unit 130 (S224). If it is determined that the moving body in the first overlapping part R1 is sensed (S224-Yes), the operation of the first sensing unit 110 stops (S225).

Next, it is determined whether the moving body deviates from the third sensing range S3 of the third sensing unit 130 (S226) and if it is determined that the moving body deviates from the third sensing range S3 (S226-Yes), the operation of the first sensing unit 110 and the second sensing unit 120 is resumed (S227). Next, it is determined whether the exit to the entrance 101 side of the moving body is sensed by the first sensing unit 110 (S228). This is a step of determining the exit of the moving body and when the exit of the moving body to the entrance 101 side is determined, the exit determination of the moving body is sensed by the first sensing unit 110 (S228-Yes) and then the count of the moving body is increased by −1 (S229). That is, according to the exemplary embodiment of the present invention, the control unit reduces the number of moving bodies within the object space 100 by 1 when the exit of the moving body is determined by the first to third sensing units.

The control unit is operated like a flow chart illustrated in FIG. 6 and accurately determines when the moving body again enters the object space 100 while the moving body exits and when the exit to the entrance 101 is determined to count the number of moving bodies. Further, the error due to the mutual interference between the first sensing unit 110 and the second sensing unit 120 using the same current is minimized and thus the accuracy is more improved.

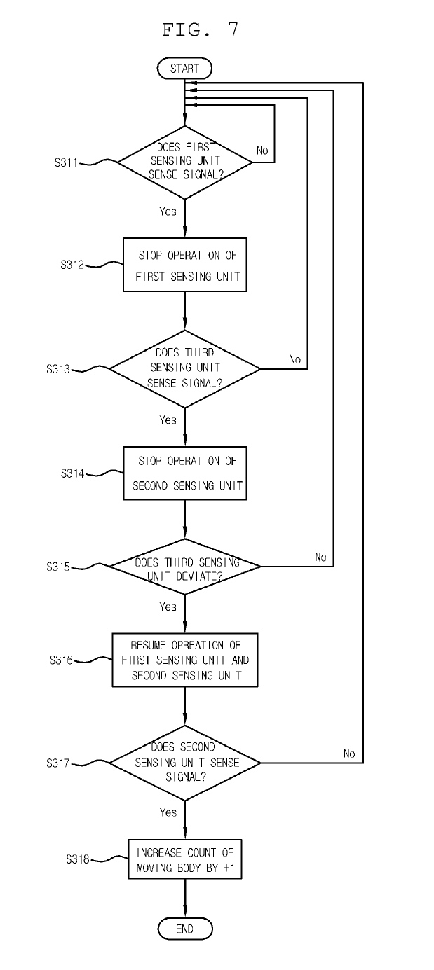

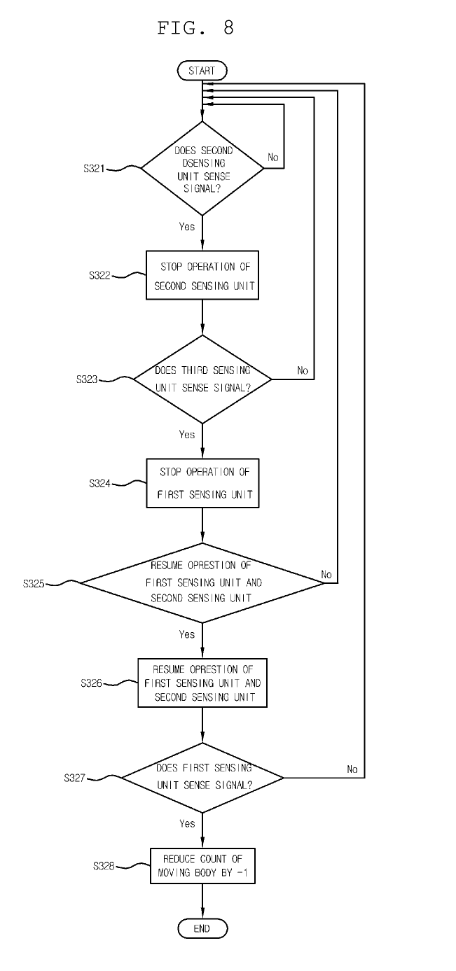

FIGS. 7 and 8 illustrate an operation flow chart of a counting method for recognizing entrance/exit directions according to a third exemplary embodiment of the present invention. FIG. 7 illustrates a counting method when the moving body is entered and FIG. 8 illustrates a counting method when the moving body exits.

Referring to FIG. 7, first, the control unit determines whether the entrance of the moving body is sensed by the first sensing unit 110 (S311). When the moving body passes through the entrance 101 of the object space 100, the entrance of the moving body is sensed by the first sensing unit 110 (S311-Yes) and the operation of the first sensing unit 110 stops (S312). Next, the control unit determines whether the moving body is sensed by the third sensing unit 130 (S313). When the moving body is continuously attempted to be entered, the heat of the moving body is sensed by the third sensing unit 130 (S313-Yes) and the operation of the second sensing unit 120 stops (S314).

Next, it is determined whether the moving body deviates from the third sensing range S3 of the third sensing unit 130 (S315) and if it is determined that the moving body deviates from the third sensing range S3 (S315-Yes), the operation of the first sensing unit 110 and the second sensing unit 120 is resumed (S316). Next, it is determined whether the entrance of the moving body is finally sensed by the second sensing unit 120 (S317). This is a step of determining the entrance of the moving body and when the entrance of the moving body is determined, the entrance determination of the moving body is sensed by the second sensing unit 120 (S317-Yes) and then the count of the moving body is increased by +1 (S318). That is, according to the exemplary embodiment of the present invention, the control unit increases the number of moving bodies within the object space 100 by 1 when the entrance of the moving body is determined by the first to third sensing units.

Therefore, the control unit accurately determines when the moving body again exits the entrance 101 while the moving body enters the object space 100 and when the entrance into the object space 100 is determined to count the number of moving bodies. Further, the error due to the mutual interference between the first sensing unit 110 and the second sensing unit 120 using the same current is minimized and thus the accuracy is more improved.

Further, referring to FIG. 8, first, the control unit determines whether the exit of the moving body is sensed by the second sensing unit 120 (S321). When the moving body attempts to exit from the object space 100, the exit of the moving body is sensed by the second sensing unit 120 (S321-Yes) and the operation of the second sensing unit 120 stops (S322). Next, the control unit determines whether the moving body is sensed by the third sensing unit 130 (S323). When the moving body continuously attempts to exit, the heat of the moving body is sensed by the third sensing unit 130 (S323-Yes) and the operation of the first sensing unit 110 stops (S324).

Next, it is determined whether the moving body deviates from the third sensing range S3 of the third sensing unit 130 (S325) and if it is determined that the moving body deviates from the third sensing range S3 (S325-Yes), the operation of the first sensing unit 110 and the second sensing unit 120 is resumed (S326). Next, it is determined whether the exit of the moving body is finally sensed by the first sensing unit 110 (S327). This is a step of determining the exit of the moving body and when the exit of the moving body is determined, the entrance determination of the moving body is sensed by the first sensing unit 110 (S327-Yes) and then the count of the moving body is increased by +1 (S328). That is, according to the exemplary embodiment of the present invention, the control unit reduces the number of moving bodies within the object space 100 by 1 when the entrance of the moving body is determined by the first to third sensing units.

Therefore, the control unit accurately determines when the moving body again exits the entrance 101 while the moving body enters the object space 100 and when the entrance into the object space 100 is determined to count the number of moving bodies. Further, the error due to the mutual interference between the first sensing unit 110 and the second sensing unit 120 using the same current is minimized and thus the accuracy is more improved.

The present invention should not be construed to being limited to the above-mentioned exemplary embodiment. The present invention may be applied to various fields and may be variously modified by those skilled in the art without departing from the scope of the present invention claimed in the claims. Therefore, it is obvious to those skilled in the art that these alterations and modifications fall in the scope of the present invention.

1. A counting apparatus for recognizing entrance/exit directions, comprising:
a first sensing unit configured to be disposed within an object space, sense a moving body within a first sensing range which is configured to be at an entrance/exit side or toward an adjacent portion to the entrance/exit side;
a second sensing unit configured to be disposed within the object space and sense a moving body within a second sensing range which is configured to be toward a space spaced apart from the first sensing range at a predetermined distance;
a third sensing unit configured to be disposed within the object space and sense a moving body within a third sensing range which is configured to be toward a space between the first sensing range and the second sensing range; and
a control unit configured to confirm whether the moving body is sensed by the first sensing unit or the second sensing unit when the moving body deviates from the third sensing range to increase a count of the moving body by +1 when the second sensing unit senses the moving body and reduce the count of the moving body by −1 when the first sensing unit senses the moving body.

2. The counting apparatus of claim 1, wherein the first sensing unit and the second sensing unit include an operation sensing sensor sensing an operation of the moving body and the third sensing unit includes a heat sensing sensor sensing heat of the moving body.

3. The counting apparatus of claim 1, wherein the third sensing range includes a first overlapping range overlapping the first sensing range and a second overlapping range overlapping the second sensing range.

4. The counting apparatus of claim 3, wherein the third sensing range is equal to or larger than a sum of the first overlapping range and the second overlapping range.

5. The counting apparatus of claim 3, wherein the control unit stops an operation of the first sensing unit when the first sensing unit senses the moving body and then the moving body enters the first overlapping range, stops an operation of the second sensing unit when the second sensing unit senses the moving body and then the moving body enters the second overlapping range, and resumes the operation of the first sensing unit and the second sensing unit when the moving body deviates from the third sensing range.

6. The counting apparatus of claim 1, wherein at least two of the first sensing unit, the second sensing unit, and the third sensing unit are packaged in a single operation sensing sensor.

7. A counting method for recognizing entrance/exit directions, comprising:
sensing, by a first sensing unit, a moving body when the moving body is entered;
sensing, by a third sensing unit, the moving body;
confirming whether the first sensing unit or the second sensing unit senses the moving body when the moving body deviates from a third sensing range;
increasing a count of the moving body by +1 when the second sensing unit senses the moving body;
sensing, by the second sensing unit, the moving body when the moving body exits;
sensing, by a third sensing unit, the moving body;
confirming whether the first sensing unit or the second sensing unit senses the moving body when the moving body deviates from the third sensing range; and
reducing the count of the moving body by −1 when the first sensing unit senses the moving body;

8. The counting method of claim 7, further comprising:
stopping an operation of the first sensing unit when the moving body enters the third sensing range or a first overlapping range after the first sensing unit senses the moving body; and
stopping an operation of the second sensing unit when the moving body enters the third sensing range or a second overlapping range after the second sensing unit senses the moving body.

9. The counting method of claim 7, further comprising:
stopping an operation of the first sensing unit when the first sensing unit senses the moving body, stopping an operation of the second sensing unit when the third sensing unit senses the moving body, or stopping the operation of the second sensing unit when the second sensing unit senses the moving body and stopping the operation of the first sensing unit when the third sensing unit senses the moving body.

10. The counting method of claim 8, further comprising:
resuming the operation of the first sensing unit and the second sensing unit when the moving body deviates from the third sensing range.

11. The counting apparatus of claim 4, wherein the control unit stops an operation of the first sensing unit when the first sensing unit senses the moving body and then the moving body enters the first overlapping range, stops an operation of the second sensing unit when the second sensing unit senses the moving body and then the moving body enters the second overlapping range, and resumes the operation of the first sensing unit and the second sensing unit when the moving body deviates from the third sensing range.

12. The counting apparatus of claim 2, wherein at least two of the first sensing unit, the second sensing unit, and the third sensing unit are packaged in a single operation sensing sensor.

13. The counting method of claim 9, further comprising:
resuming the operation of the first sensing unit and the second sensing unit when the moving body deviates from the third sensing range.
